(19) United States
(12) Patent Application Publication
(10) Pub. No.: US 2017/0113576 A1
(43) Pub. Date: Apr. 27, 2017

(54) INFANT SEAT FOR MOTORCARS

(71) Applicant: Jane, S.A., Palau Solita I Plegamans (Barcelona) (ES)

(72) Inventor: Manuel JANE SANTAMARIA, Palau Solita I Plegamans (Barcelona) (ES)

(73) Assignee: Jane, S.A., Palau Solita I Plegamans (Barcelona) (ES)

(21) Appl. No.: 14/982,425

(22) Filed: Dec. 29, 2015

(30) Foreign Application Priority Data
Oct. 21, 2015 (ES) 201531143U

(51) Int. Cl. B60N 2/28

(52) U.S. Cl. CPC B60N 2/2812; B60N 2/2851

(57) ABSTRACT

The aim of this invention is to facilitate a solution to this problem of replacing the five-point straps from the child's chair with the car's own safety belt and vice versa, so that anyone can manage to change between these two infant seat layouts without difficulty, in a totally reliable manner (i.e., fool proof), and in a totally efficient way, to achieve these advantages, the infant seat proposed by this invention has a particular structure that enables the straps to be stored in a concealed place without affecting the comfort and safety of the seat, and additionally, it comprises means related to the mechanism by which the headrest of the seat is lifted as the child grows.

### OBJECT OF THE INVENTION

Infant seat for motorcars.

### BACKGROUND OF THE INVENTION

There are several types of infant seats for motorcars, which generally have safety straps for the child when it is small (generally up to the age of four or five) having basically two straps joined by a buckle to a crotch strap, the seat also has a height-adjustable headrest.

These infant seats are fitted to the rear motorcar seats, having mechanical means to secure the infant seat attached to the means provided in the motorcar, such as a lower platform with art Isofix system.

Some of these seats are prepared for use by children of different ages, for which the child straps, commonly called a five-point belt, are attached to the seat with means to adjust their length. However, when the child is older (from the age of four or five), it is necessary to replace these straps and instead use the car safety belt with the infant seat until the child as about 12 years old.

In this case, when the child is older (from the age of 4 or 5), the five-point straps fitted to the seat are a bother in the safety seat and need to be removed, as the seat belt of the car is now used to hold the older child in the infant seat. Removing the five-point belt from the seat is normally complicated, takes a long time and is difficult for the user, who is normally a person unfamiliarised with this sort of disassembly.

### SUMMARY OF THE INVENTION

The aim of this invention is to facilitate a solution to this problem of replacing the five-point straps from the child's chair with the car's own safety belt and vice versa, so that anyone can manage, to change between these two infant seat layouts without difficulty, in a totally reliable manner (i.e., fool proof), and in a totally efficient way.

To achieve these advantages, the infant seat proposed by this invention has a particular structure that enables the straps to be stored in a concealed place without affecting the comfort and safety of the seat, and additionally, it comprises means related to the mechanism by which the headrest of the seat is lifted as the child grows.

The aforementioned structure, for the passive positioning of the straps and the belt corresponding to the straps, comprises a retaining element for the two five-point belt straps in passive position at the front of the seat back, above which there is a cover preferably made of flexible material that covers this element for holding the straps; and for the passive position of the crotch strap and the buckle there is a cavity in the part of the chair seat to hold the crotch strap and buckle inside it, this cavity has a corresponding cover for total concealment.

The mechanism used for moving the headrest comprises two independent controls, that are adapted for moving the headrest when the infant seat is used for small children (i.e., using the five-point belt), and another control is used to move the headrest when the infant seat is used for older children (i.e., using the car's safety belt), and with the feature that while one of these is being used, the other is automatically locked, and vice versa. Therefore, when the small child has grown and the infant seat is in the highest position of the five-point belt configuration, the user can conceal (without having to remove) the different parts of the five-point belt in the same seat and only then can the second control be used (as it will now be unlocked) to move the headrest when the infant seat is in the configuration for older children.

These and other features will be best made apparent by the following detailed description whose understanding will be made easier by the accompanying 8 sheets of drawings showing a practical embodiment being cited only by way of example not limiting the scope of the present invention.

### DESCRIPTION OF THE DRAWINGS

In the drawings:

FIG. 1 shows the infant seat this invention refers to in front elevation view, prepared for very young children, i.e. with the five-point belt installed.

FIG. 2 shows the infant seat of FIG. 1 in perspective, but without upholstery.

FIG. 3 shows a detailed front perspective view of the layout of the five-point straps in passive position, i.e., when the user conceals them to adjust the infant seat for an older child.

FIG. 4 shows, in a similar view to FIG. 2 in perspective, a detail of the housing for passive positioning of the crotch strap and strap buckle.

FIG. 5 shows a front elevation view of the infant seat ready to the used by older children, i.e., when the five-point belt has been concealed.

FIG. 6 shows a rear elevation view of the infant seat of FIG. 5, displaying the two independent controls for vertical movement of the headrest in both layouts.

FIGS. 7a and 7b show a schematic side elevation view of the locking device of one of the two controls for moving the headrest, in passive and active positions, respectively.

FIGS. 8a and 8b show a schematic frontal representation of the infant seat without upholstery in the seat configuration for older children (i.e., with the five-point belt concealed) and specifically in two different headrest height positions, that can be adjusted with the corresponding control.

FIG. 9 gives an exploded view of a front perspective of the infant seat without upholstery and without the back plate, prepared for use by older children, i.e., with the five-point belt concealed.

FIG. 10 gives a partial section plan view of the concealing system for the straps and the locking device for the two configurations of the infant seat, on the left, the strap is in active position, while on the right the strap is in inactive position (concealed).

### DETAILED DESCRIPTION OF A PREFERRED EMBODIMENT

According to the drawings, the infant seat (1) for motorcars comprises a back (29) and a part of the seat (22) and, in this specific case, on a lower platform (27) that may incorporate an Isofix type system for securing to the motorcar with its corresponding adjustment control (25) to the vehicle.

Optionally the infant seat (1) may be inclined with regard to the horizontal plane of the lower platform (27) by acting on a control (28).

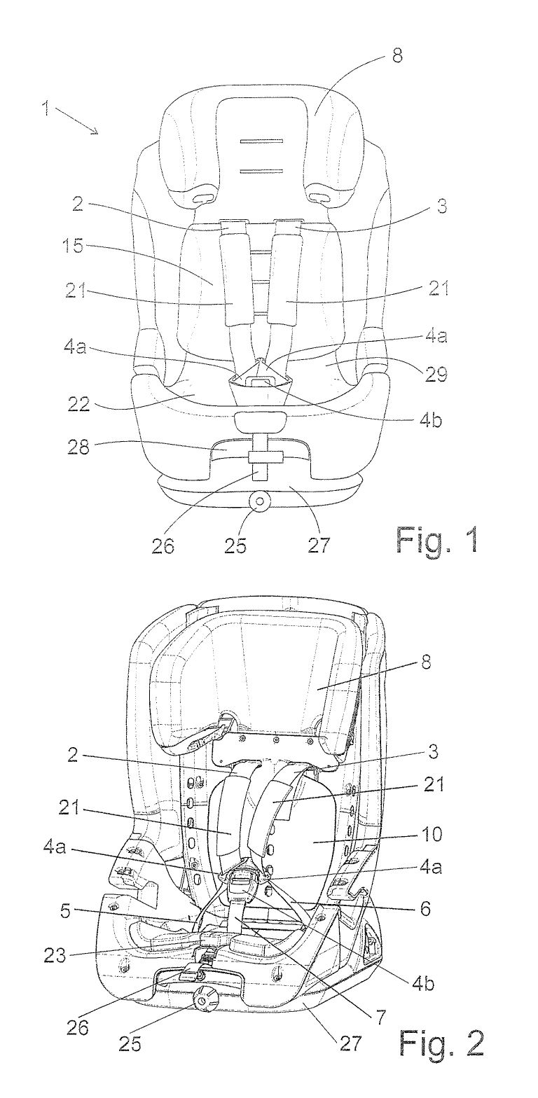

This infant seat (1) also comprises a headrest (8) that can be adjustable to different heights by acting on the corresponding control(s), see FIG. 1.

The infant seat (1) comprises a five-point strap system with two vertical straps (2 and 3) passing through an upper part (4a) of a buckle and which are extended to the lower sections (5 and 6) to act like a safety belt when the child is small, a crotch strap (7) is attached to the lower part of (4b) of the buckle, see FIG. 2.

These vertical straps (2 and 3) can incorporate respective protectors (21) for greater comfort of the small child, see FIG. 1 or 2.

These five-point straps (2, 3, 4, 5, 6, 7) may be adjustable by means of a conventional mechanism, to adapt to the actual size of the child, pulling or releasing the front end of the belt (26) that projects from the lower part of the infant seat (1).

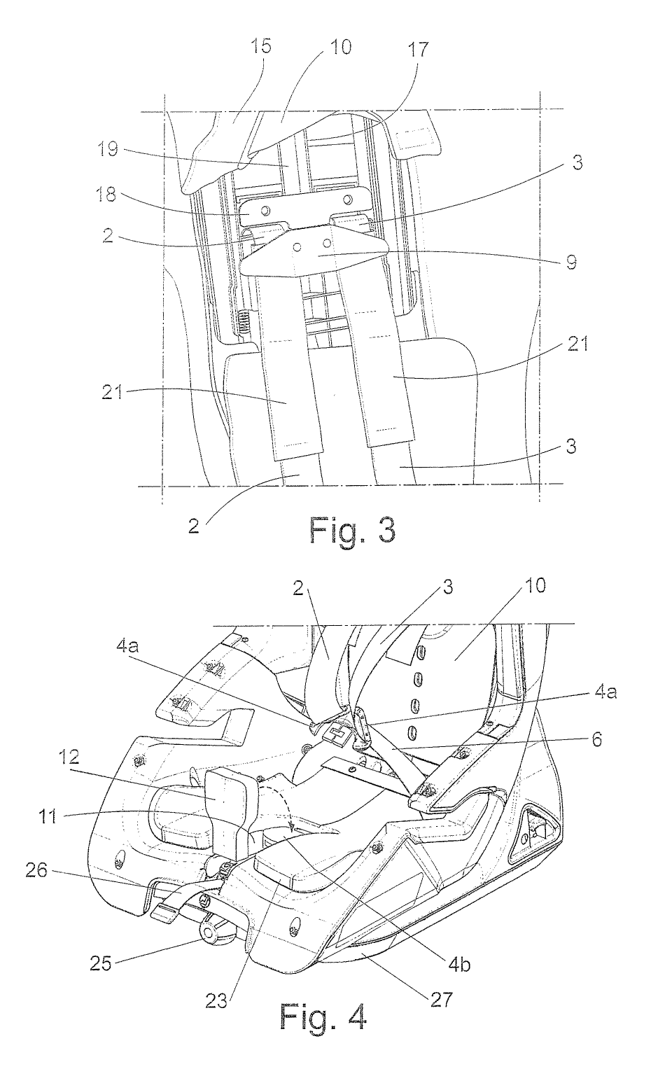

These five-point straps (2, 3, 4. 5, 6, 7) can be placed in a concealed passive position by the user, for which purpose the vertical straps (2 and 3) are placed behind a retaining element (9), at the front of the seat back (29) (see FIG. 3), with a cover (10) on the front preferably flexible (see FIG. 2), that conceals these straps (2 arid 3) from the view of the older child.

Regarding the lower part (4b) of the buckle and the crotch strap (7), the user may also place them in a passive position, for which purpose there is a cavity (11) in the part of the seat (22) of the chair (1) where they are housed, this cavity (11) has the necessary dimensions to house the lower part (4b) of the buckle and the crotch strap (7) inside it and is closed with a cover (12) so as not to bother the older child, see FIG. 4. To access this cover (12) the user must remove the upholstery covering the part the seat (22) and then get to the inside (23) of the part of the seat (22) where you can find said cavity (11).

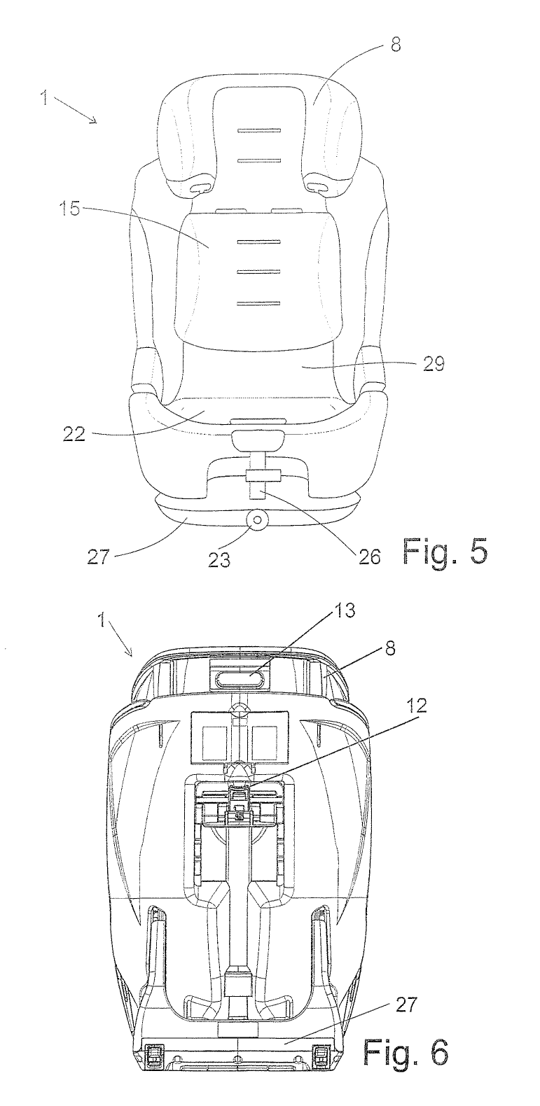

The mechanism used to move the headrest (8) comprises at least a first (12) and a second control (13), the first (12) is located at the lower part of the seat back and the second in the post upper part of the headrest (8), see FIG. 6. The first control (12) is used to move the headrest (8) when the infant seat is used for small children (FIG. 1), while the second control (13) is used to move the headrest (8) when the infant seat is used for older children (FIG. 5).

Each of these controls (12 and 13) can place the headrest (8) at different heights.

In a preferred embodiment of this invention, there is a sliding element holding the five-point belt (18) and another sliding element holding the headrest (19), these move respectively the five-point belt or the headrest vertically along the vertical axis (17) of the infant seat chassis to different heights.

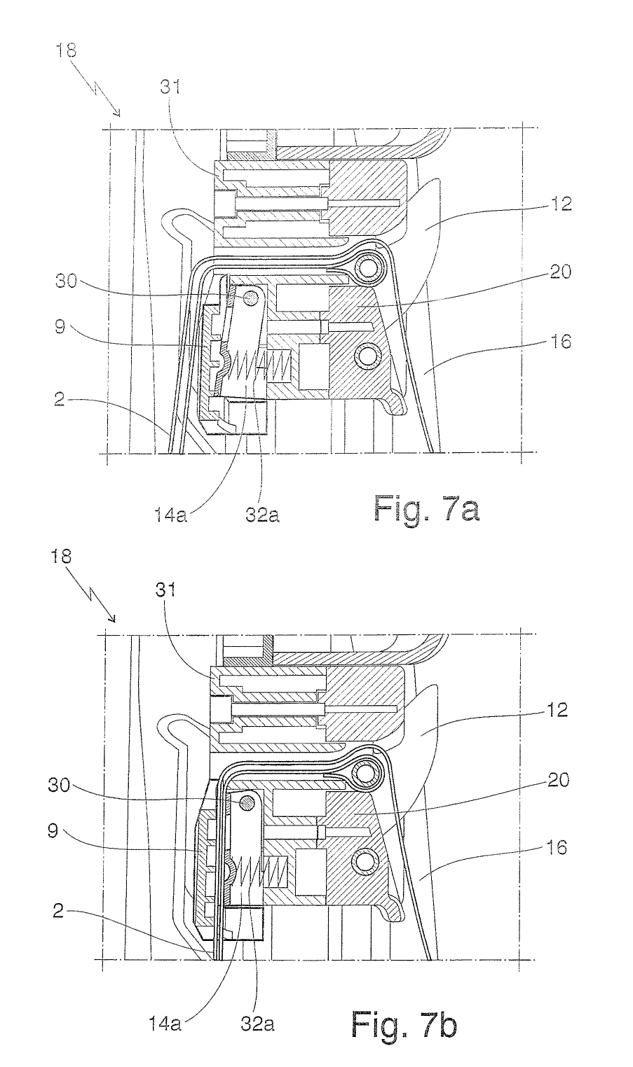

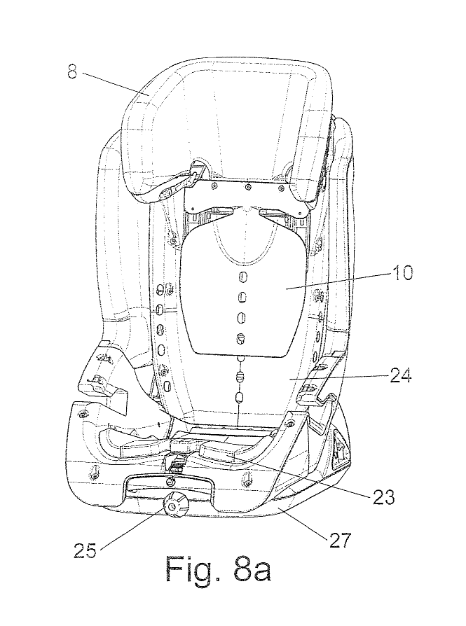

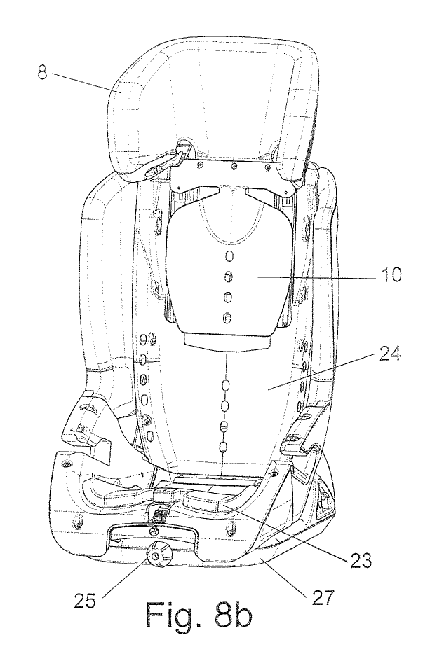

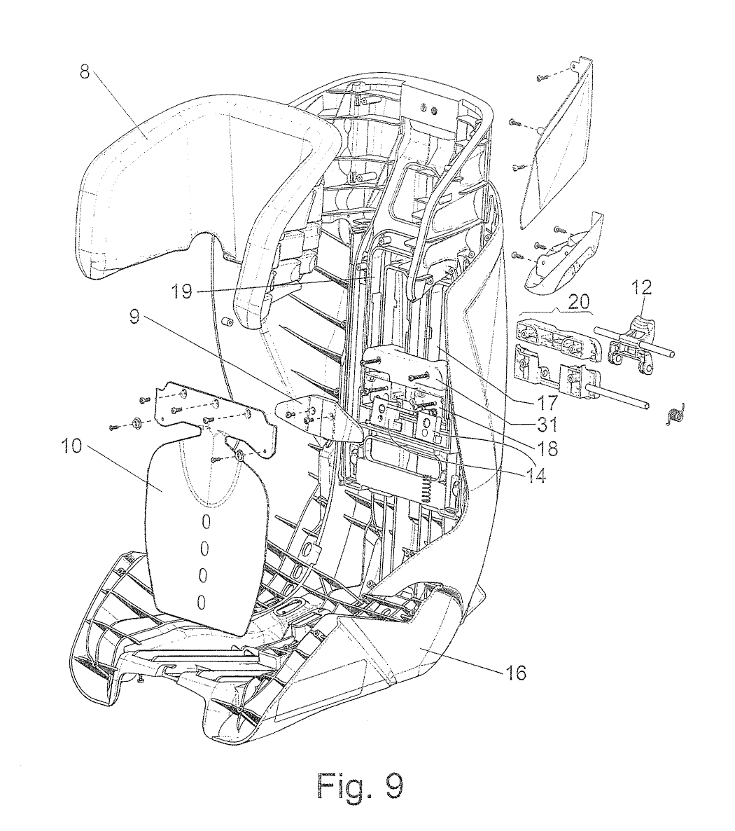

The great advantage of this mechanism is that while the first control (12) is used, the second control (13) is locked, for which purpose there is a locking device (14) in the mechanism used to move the headrest (see FIGS. 7a and 9), which has two different positions: the first for locking the sliding element holding the five-point belt and at the same time unlocking the sliding element holding the headrest (19), and the second position unlocking the sliding element holding the five-point belt (18) and at the same time locking the sliding element holding the headrest (19).

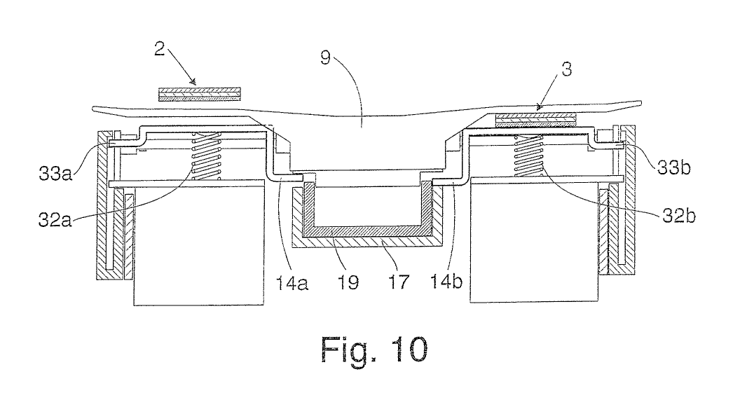

These two different positions of the locking device (14) are enabled/disabled in the following manner, see FIGS. 7a, 7b and 10;
when the infant seat (1) is set up for small children (left FIGS. 7a. and 10) with the straps (2 and 3) in active position, in this case there are two locking elements (14), one for each strap, the locking elements (14) being in a first position, in which the sliding element holding the five-point belt (18) is unlocked, therefore it can move freely along the guide or vertical axis (17) of the seat, adopting different heights according to the operation of the lower control (12).
When the user conceals the straps (2 and 3) to occupy a passive position (right FIGS. 7b and 10) and wishes to place the seat (1) in the position for older children, these locking elements (14) will then be active, locking the sliding element holding the five-point belt (18) and at the same time unlocking the sliding element holding the headrest (13). In this second position, the sliding element holding the five-point belt (18) is fixed in a certain position, while the sliding element holding the headrest (13) can move freely upwards according to different heights set by the upper control (13). In this position, the user can no longer operate the lower control (12).

Preferably, both the sliding element holding the five-point belt (18) and the one holding the headrest (19) move vertically up or down, guided by a vertical central guide (17) on the chassis (16) of the infant seat (1), see FIG. 9.

According to a preferred embodiment, the sliding element, holding the five-point belt (18) comprises the straps retaining element (9), the locking element/s (14), elements for securing the five-point belt (20) at the rear linked to the lower control (12) for moving the headrest when the child is small, see FIGS. 7a and 7b. This sliding element holding the five-point belt (18) may also comprise another additional part (31) on the upper part that is a lower stop for the movement of the sliding element holding the headrest (19).

According to a preferred embodiment, the sliding element holding the headrest (19) comprises the chassis of the headrest that comprises the upper control (13) and there are vertical guides for locking/unlocking the sliding element holding the headrest (19) and to establish different heights, see FIG. 9.

The locking device (14) of one of the controls for moving the headrest (8) and its operation are clearly shown in FIGS. 7a and 7b and also in FIG. 9. In the first FIG. 7a shows the straps (2 and 3) in active position, while in the next FIG. 7b the straps (2 and 3) have been concealed behind the retaining element (9). In the second position (FIG. 7b), as the straps (2 and 3) pass behind the retaining piece (9) they press on the locking element/s (14) that are behind the piece (9). This/these locking element/s (14) is/are responsible for locking the sliding element holding the five-point belt (18) and at the same time unlocking the upper control (13) for moving the headrest when the child is older.

As shown in these FIGS. 7a, 7b and 9, both locking elements (14) are linked to the retaining element (9) of the straps (2 and 3), so that as the straps (2 and 3) are between the retaining element (9) and the locking elements (14) to hide these straps (2 and 3), the straps press on the locking elements (14) that vary their position and then release the sliding element holding headrest (19) for moving vertically by means of the corresponding control (13).

According to a preferred embodiment of the locking device (14), it comprises two locking elements (14a, 14b) with their respective rocking shafts (30), respective elastic elements, such as springs (32a, 32b), to return them to resting position, and or more tabs (33a, 33b) to carry out this locking or unlocking of the sliding element for moving the headrest (19), see FIG. 9.

This locking device (14) is preferably configured by an independent part (14a, 14b) for each belt, so that if the two belts are not concealed, it will not be possible to unlock the sliding element for moving the headrest (19) when the child is older.

FIG. 9 shows a possible configuration of the retaining element (9) of the straps, consisting of a body with two side wings, fitted in such a manner that between the side wings and the upper face of each locking element (14a, 14b) there is enough space to hold the straps (2, 3) inside.

The sliding element holding the five-point belt (18) when the child is small and the sliding element for moving the headrest (19) when the child has grown may vary their configuration and components without altering the essence of this invention.

The upholstery of the infant seat (1) has a skirt (15) preferably on the front of the seat back that covers the cover (10) and gives access to the rear part for concealing the straps (2, 3).

The upholstery of the infant seat (1) also comprises preferably on the seat (22) cloth or textile material (23) that covers the lower part, of the seat (22).

The invention can within the essentiality be put into practice in other embodiments only in detail differing from the one having been described above only by way of example, said other embodiments also falling within the scope of the protection being claimed.

This infant seat for motorcars may thus be manufactured in any shape and size, with the most suitable means and materials and with the most convenient accessories, and the components may be replaced by others that are technically equivalent, as all of this is contained within the spirit of the claims.

1. An infant seat for motorcars comprising a set of straps to restrain a child and a height-adjustable headrest, wherein it presents a structure enabling the straps to be concealed when not in use and comprises a mechanism for moving the headrest.

2. The infant seat for motorcars according to the claim 1, wherein the aforementioned structure, for the passive positioning of the straps and the belt corresponding to the straps, comprises a retaining element adapted to retain the straps in passive position, over which a flexible cover is placed.

3. The infant seat for motorcars according to the claim 1, wherein t the aforementioned structure, for the passive positioning of the crotch strap belonging to the strap system, has a cavity in the seat part with its corresponding cover.

4. The infant seat for motorcars according to the claim 1, wherein the mechanism used to move the headrest has a first and a second control, the first is used when the straps are in normal active position, and the second control is for use when the straps are in passive position.

5. The infant seat for motorcars according to the claim 1, wherein the structure for the mechanism used to move the headrest has a locking system that locks the second control when the straps are in normal active position, and this is unlocked when the straps are in passive position.

6. The infant seat for motorcars according to claim 1, wherein the infant seat has a movement sliding element for the five-point, belt when the child is small and another sliding element for moving the headrest when the child has grown, which both are independent.

7. The infant seat for motorcars according to claim 1, wherein the movement sliding element for the five-point belt and the movement sliding element of the headrest are guided by a vertical guide in the chassis of the child seat.

8. The infant seat for motorcars according to claim 1, wherein the locking device has at least one locking element linked to the straps retaining element, so that when the straps are placed between the retaining element and the locking element, these straps press against the locking element that acts on the movement sliding element of the headrest when the child is small and locks it, and at the same time this looking element acts to unlock the movement sliding element of the headrest when the child has grown.

9. The infant seat for motorcars according to claim 5, wherein t the locking device has two different and independent elements, one for each strap, attached to the to the strap retaining element.

10. The infant seat for motorcars according to claim 9, wherein each locking element has its own tilting axis so it can adopt two different positions, and its respective elastic element to return to resting position, and with one or more tabs adapted to lock or unlock the movement sliding element of the headrest.
